(19) United States
(12) Patent Application Publication
(10) Pub. No.: US 2010/0082551 A1
(43) Pub. Date: Apr. 1, 2010

(54) DATA PLACEMENT TRANSPARENCY FOR HIGH AVAILABILITY AND LOAD BALANCING

(75) Inventors: Vishal Kathuria, Woodinville, WA (US); Robert H. Gerber, Bellevue, WA (US); Mahesh K. Sreenivas, Sammamish, WA (US); Yixue Zhu, Sammamish, WA (US); John Ludeman, Redmond, WA (US); Ashwin Shrinivas, Sammamish, WA (US); Ming Chuan Wu, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/238,852

(22) Filed: Sep. 26, 2008

(51) Int. Cl. G06F 17/30

(52) U.S. Cl. 707/674; 707/E17.002

(57) ABSTRACT

A method of updating a clone data map associated with a plurality of nodes of a computer system is disclosed. The clone data map includes node identification data and clone location data. A node failure event of a failed node of the computer system that supports a primary clone is detected. The clone data map is updated such that a secondary clone stored at a node other than the failed node is marked as a new primary clone. In addition, clone data maps may be used to perform node load balancing by placing a substantially similar number of primary clones on each node of a node cluster or may be used to increase or decrease a number of nodes of the node cluster. Further, data fragments that have a heavy usage or a large fragment size may be reduced in size by performing one or more data fragment split operations.

### BACKGROUND

In scalable distributed systems, data placement of duplicate data is often performed by administrators. This may make system management difficult since the administrator has to monitor the workload and manually change data placement to remove hotspots in the system or to add nodes to the system, often resulting in system down time. Moreover, to enhance the placement of data so that related items of data are located together, the administrator takes into account the relationships of various objects, resulting in increased complexity as the number of objects in the system grows.

One manner of scaling and balancing workload in a database system uses clones of data fragments. Clones represent copies of fragments of database objects. The use of clones enables two or more copies of a particular data fragment to be available.

### SUMMARY

The present disclosure describes a fragment transparency mechanism to implement an automatic data placement policy to achieve high availability, scalability and load balancing. Fragment transparency allows multiple copies of data to be created and placed on different machines at different physical locations for high availability. It allows an application to continue functioning while the placement of underlying data changes. This capability may be leveraged to change the location of the data for scaling and for avoiding bottlenecks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts dividing a database object managed by a database system into clones;

FIG. 2 depicts distribution of clones across network nodes;

FIG. 3 shows a particular illustrative embodiment of a clone data map that may be used with a distributed computing system that uses a database object;

FIG. 4 shows another particular illustrative embodiment of a clone data map that may be used with a distributed computing system that uses a database object;

FIG. 5 depicts migration of clones to a new node;

FIG. 6 depicts reduction of fragment size to reduce load on the fragment or to bring the fragment size closer to an average fragment size;

FIG. 7 depicts failover scenarios of a distributed computing system;

FIG. 8 is a flow diagram depicting a particular embodiment of a method of updating a clone data map associated with a plurality of nodes of a computer system;

FIG. 9 is a flow diagram depicting a particular embodiment of a method of adding a node to a node cluster; and

FIG. 10 is a flow diagram depicting a particular embodiment of a method of load balancing clones across nodes of a node cluster.

### DETAILED DESCRIPTION

In a particular embodiment, a method of updating a clone data map associated with a plurality of nodes of a computer system is disclosed. The clone data map includes node identification data and clone location data. The method includes detecting a node failure event of a failed node of the computer system. The failed node may support a primary clone. In response to the detected node failure event, the method includes updating the clone data map. The clone data map is updated such that a secondary clone stored at a node other than the failed node is marked as a new primary clone.

In another particular embodiment, a method of adding a node to a node cluster is disclosed. The method includes identifying a set of clones to be migrated to a new node of a computing system. Each clone in the set of clones includes a replicated data fragment stored at a different storage location at the computing system. The method includes creating an entry in a clone data map for the new node to generate new clones. The method also includes refreshing each of the new clones from a corresponding current primary clone to generate new refreshed clones. The method further includes designating each of the new refreshed clones as either primary or secondary in the clone data map.

In another particular embodiment, a computer-readable medium for use with a method of load balancing clones across nodes of a node cluster is disclosed. The computer-readable medium includes instructions, that when executed by a processor, cause the processor to identify fragments in the set of data fragments that have heavy usage, wherein each of the data fragments have a similar size or the same size. The computer-readable medium includes instructions, that when executed by the processor, cause the processor to reduce the size of the identified fragments that have heavy usage until the load on each of the identified fragments is substantially the same as the other fragments. The size of the data fragment is reduced by performing one or more data fragment split operations that are non-observable by an associated application. The computer-readable medium further includes instructions, that when executed by the processor after reducing the size of the identified fragments, cause the processor to perform node load balancing by placing a substantially similar number of primary clones on each node of a node cluster.

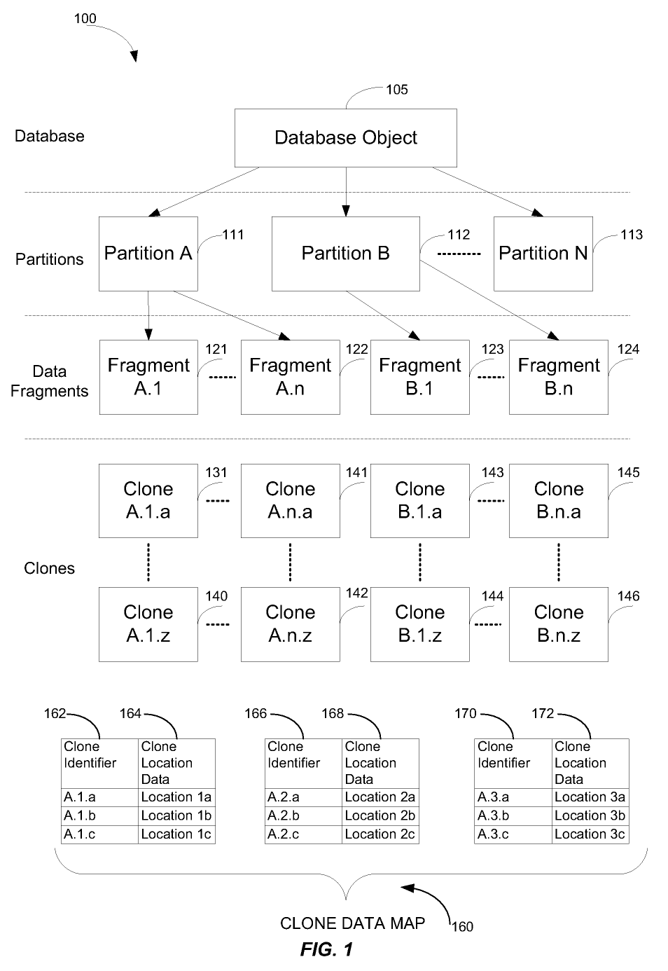

FIG. 1 shows an example cloning data structure 100 of a database object 105 managed by a database system. A database is a collection of information organized in a manner that enables desired pieces of data in the database to be quickly selected or updated. A database object may include the entire database or any portion of the database. For example, the database object 105 may be an entire table, an index, a set of rows (e.g., a rowset), or the like.

The database object 105 may be divided into partitions 111-113. Typically, the database object 105 is partitioned for convenience or performance reasons. For example, the database object 105 may include data associated with multiple years. The database object 105 may be divided into partitions 111-113 where each partition is associated with a particular year. Partitioning of the database object 105 is an optional step that may or may not be implemented in an actual implementation.

Each partition 111-113 of the database object 105 (or the entire, unpartitioned database object 105) is typically divided into fragments, such as data fragments 121-124. The data fragments 121-124 are portions of the database object 105 divided by the database system on an operational basis. For example, the data fragments 121-124 may be assigned to different computing devices so that a query associated with the database object 105 may be performed by the computing devices working in parallel with the different data fragments 121-124.

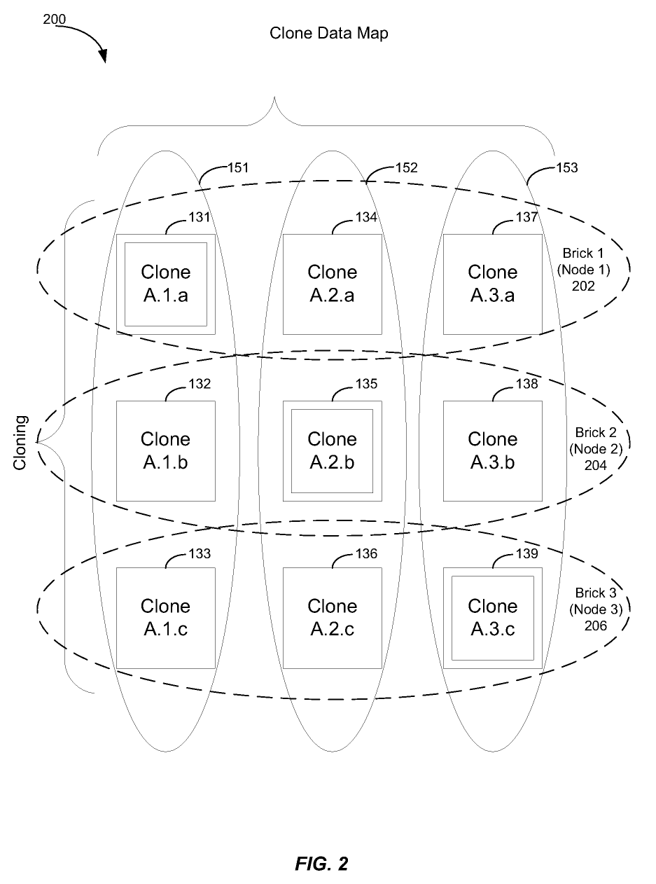

Fragments in the database object 105 are further cloned to create clones. As shown in FIG. 1, each of data fragments 121-124 are cloned to produce actual clones, such as clones 131, and 140-146. Typically, fragments of a database object (or of a partition of a database object) are created by splitting the database object into discrete sets of rows or rowsets (for tables) or index entries (for indices). Hashing on a key of a table or index is one basis for accomplishing such splitting. Clones will be discussed in more detail in conjunction with FIG. 2. Briefly stated, when properly updated, clones associated with a particular data fragment of the database object 105 are operationally identical so that the clones may be readily used by the database system. The use of clones enables two or more copies of a particular fragment to be available, for example to maintain a high level of data availability, to speed up queries and other database operations, to perform load-balancing, or the like. For example, to maintain a high level of data availability, at least one clone may serve as a backup of another clone that is used for database operations. To speed up searches, multiple operationally identical clones may be used concurrently for database queries. To perform load-balancing, different, but operationally identical copies of clones may be activated based on workload conditions.

FIG. 1 also shows a clone data map 160. The clone data map 160 includes clone location data for one or more clones. In the embodiment illustrated, the clone data map 160 includes clone identifiers 162, 166 and 170 and clone location data 164, 168 and 172 for three groups of clones. For example, referring to columns 162 and 164, clone identifier A.1.a is mapped to clone location 1a; clone identifier A.1.b is mapped to clone location 1b; and clone identifier A.1.c is mapped to location 1c. As another example, referring to columns 166 and 168, clone identifier A.2.a is mapped to clone location 2a; clone identifier A.2.b is mapped to clone location 2b; and clone identifier A.2.c is mapped to location 2c. As a further example, referring to columns 170 and 172, clone identifier A.3.a is mapped to clone location 3a; clone identifier A.3.b is mapped to clone location 3b; and clone identifier A.3.c is mapped to location 3c. In a particular embodiment, clone location data includes a brick identifier, which identifies the computer on which the data is located, and a rowset identifier, which identifies the specific location of the data on that brick.

FIG. 2 shows an example of a clone data map 200 including clones 131-139 of a database object. As shown, the clones 131-139 can be viewed as three groups 151-153. Each group of clones is related to a particular fragment of a database object. The clones within each group are created as operationally identical to each other. Thus, when properly updated, each of the clones 131-139 can be used for database operations that are applicable to the corresponding fragments 151-153.

In one embodiment, the clones 131-139 are configured to provide a high level of data availability. In this embodiment, a clone from each of the groups 151-153 can be designated as the primary clone for database operations. Other clones in the group are secondary clones that serve as readily available backups. In FIG. 2, the clones 131, 135 and 139 are primary clones (as indicated by additional window surrounding clones 131, 135 and 139) while the remaining clones are designated as secondary clones.

To provide a high level of data availability, each of the clones in the group may be included in different devices so that, if one of the devices fails, a secondary clone in another device can very quickly replace the clone in the failed device as the primary clone. For example, the clones 131-133 may each be included in separate devices (i.e. separate nodes) so that either of the secondary clones 132-133 may be designated as primary if the device in which the primary clone 131 is included fails. For example, the primary clone 131 is located at a first node 202 (e.g., Brick 1), while a first secondary clone 132 is located at a second node 204 (e.g., Brick 2) and a second secondary clone 133 is located at a third node 206 (e.g., Brick 3). In the embodiments shown, the terms node and brick are used interchangeably to represent location of the clones on separate devices (e.g., stored on separate computers of a multi computer system).

The database system that manages the clones may perform various operations on the clones. These operations are typically performed using standard database operations, such as Data Manipulation Language (DML) statements or other structured query language (SQL) statements. In one example implementation, operations may include:

1. Creating a clone—A clone can be created to be indistinguishable from a normal table or an index rowset in a database.

2. Deleting a clone—Clones can be deleted just as rowsets in a database are deleted.

3. Fully initializing a clone's data—A clone can be completely initialized, from scratch, to contain a new rowset that is loaded into the clone.

4. Propagating data changes to a clone—Changes to the primary clone are propagated to one or more secondary clones. Propagation occurs within the same transactional context as updates to the primary clone.

5. Refreshing a stale clone—When a clone has been offline or has otherwise not received transaction propagation of updates from the primary clone, it is defined to be a stale clone. Stale clones can also be described as outdated fragment clones. The process of bringing a stale clone back to transactional consistency with a primary fragment clone is called refresh.

6. Reading a clone—A clone can be read for purposes of data retrieval (table access) or for lookup (index access) just like normal tables or indices are read and accessed. In this implementation, user workloads may read from primary clones and are permitted to read from secondary clones when the user workload is running in a lower isolation mode, e.g., a committed read. This restriction may be used for purposes of simplifying the mechanism for avoiding unnecessary deadlocks in the system. However, this restriction may be relaxed if deadlocks are either not a problem or are avoided through other means in a given system.

7. Updating a clone—User workloads update the primary clone and the database system propagates and applies those changes to secondary clones corresponding to that primary clone within the same transaction. Propagating a change means applying a substantially identical DML operation to a secondary clone that was applied to a primary clone.

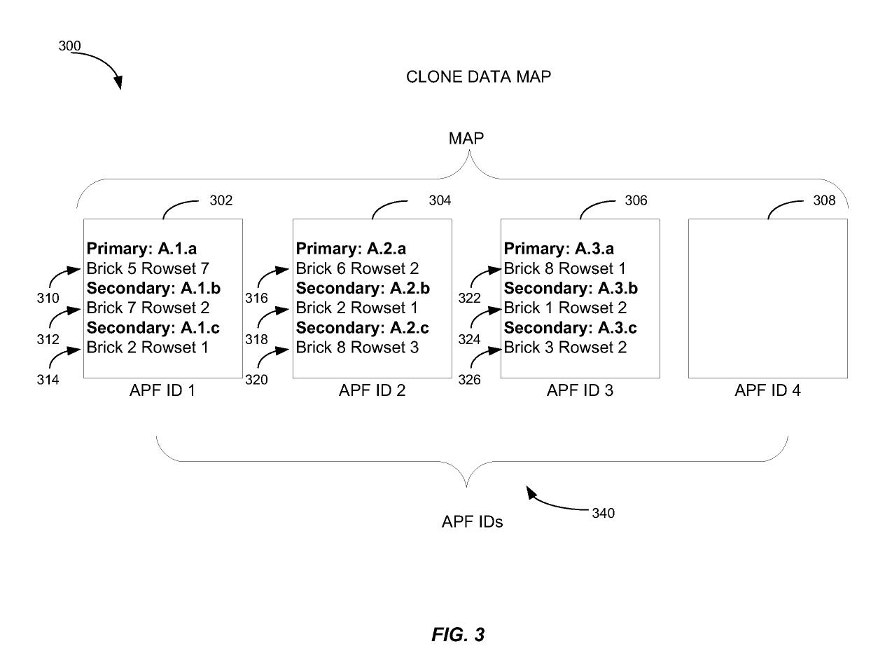

Referring to FIG. 3, a particular illustrative embodiment of a clone data map 300 that may be used with a distributed computing system that uses the database object 105 is shown. In a particular embodiment, the clone data map 300 of FIG. 3 is an example of the data structure illustrated in FIG. 2. The clone data map 300 includes clone location information for multiple actual partition fragment (APF) identifiers 340. In the embodiment shown, the clone data map 300 includes a first fragment 302, a second fragment 304, a third fragment 306, and other fragments, as represented by a null fragment 308. The first fragment 302 includes clone A.1.a 310, clone A.1.b 312, and clone A.1.c 314. The second fragment 304 includes clone A.2.a 316, clone A.2.b 318, and clone A.2.c 320. The third fragment 306 includes clone A.3.a 322, clone A.3.b 324, and clone A.3.c 326. In the embodiment shown, each of the fragments (e.g., the first fragment 302, the second fragment 304, and the third fragment 306) of the clone data map 300 includes a primary clone and two secondary clones. For example, for the first fragment 302, the clone data map 300 indicates that clone A.1.a 310 is a primary clone of the first fragment 302, and clone A.1.b 312 and clone A.1.c 314 are secondary clones of the first fragment 302. As another example, for the second fragment 304, the clone data map 300 indicates that clone A.2.a 316 is a primary clone of the second fragment 304, and clone A.2.b 318 and clone A.2.c 320 are secondary clones of the second fragment 304. Similarly, for the third fragment 306, the clone data map 300 indicates that clone A.3.a 322 is a primary clone of the third fragment 306, and clone A.3.b 324 and clone A.3.c 326 are secondary clones of the third fragment 306.

The clone data map 300 includes node identification data and clone location data. As noted above, the terms node and brick are used interchangeably to describe where clones may be located. For example, the primary clone of the third fragment 306 (e.g., clone A.3.a 322) resides on brick 8, and the clone location data is in rowset 1. In addition, secondary clone A.3.b 324 of the third fragment 306 is located on brick 1, and the clone location data is in rowset 2. Similarly, secondary clone A.3.c of the third fragment 306 is located on brick 3, and the clone location data is in rowset 2. In a particular illustrative embodiment, the clone data map 300 may be located at one of the same bricks as the clones. In an alternative illustrative embodiment, the clone data map 300 may be located on another computing system separate from the bricks where the clones are located.

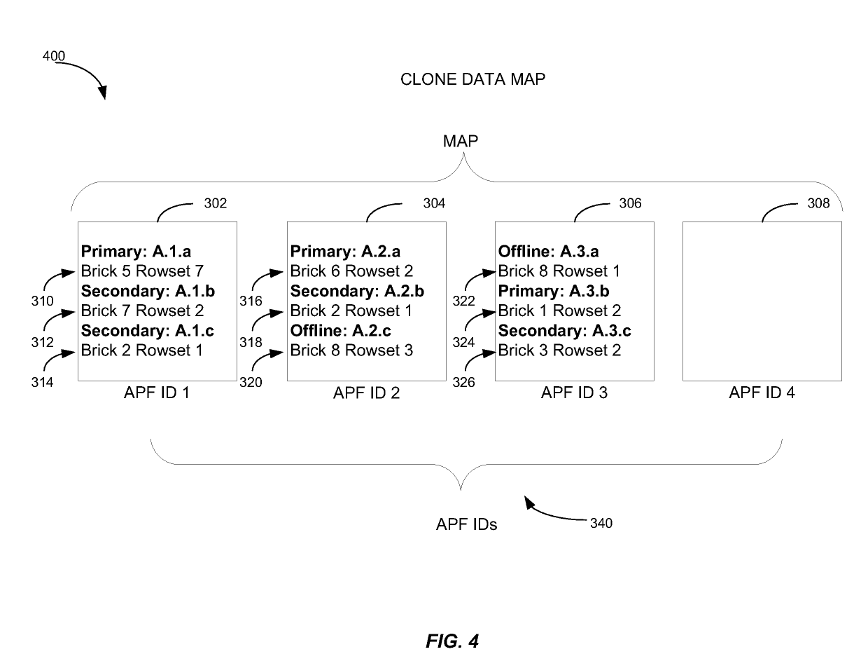

Referring to FIG. 4, another particular illustrative embodiment of a clone data map 400 is shown. In a particular embodiment, the clone data map 400 is an updated version of the clone data map 300 of FIG. 3 following the failure of brick 8. The node failure event of the failure of brick 8 causes the primary clone A.3.a 322 of the third fragment 306 and secondary clone A.2.c 320 of the second fragment 304 to go offline and, thus these clones become unavailable. The clone data map 400 of FIG. 4 has been updated so that secondary clone A.3.b 324 of the third fragment 306 of the clone data map 300 of FIG. 3 has been redesignated and updated as a new primary clone of the third fragment 306. The clone data map 400 of FIG. 4 has also been updated so that the primary clone A.3.a 322 of the third fragment 306 of the clone data map 300 of FIG. 3 has been redesignated as having a status of offline, and secondary clone A.2.c 320 of the second fragment 304 of the clone data map 300 of FIG. 3 has been redesignated as having a status of offline. The new primary clone of the third fragment 306 (e.g., clone A.3.b 324) resides on brick 1 with data located at rowset 2. Note that the first fragment 302 of the clone data map 300 of FIG. 3 has not been updated in the clone data map 400 of FIG. 4. The first fragment 302 remains unchanged because none of the clones of the first fragment 302 were located on brick 8.

FIG. 3 and 4 together illustrate a method of updating a clone data map associated with a plurality of nodes of a computer system. The method includes detecting a node failure event of a failed node. The failed node may include a primary clone and a secondary clone. For example, in the illustrated case, the failed node is brick 8, and brick 8 includes the primary clone of the third fragment 306 (e.g., clone A.3.a 322) and secondary clone A.2.c 320 of the second fragment 304. The method includes, for the primary clone (e.g., clone A.3.a 322), updating the clone data map (e.g., clone data map 400 of FIG. 4 represents an updated clone data map) in response to the detected node failure event. The clone data map 400 of FIG. 4 includes node identification data and clone location data. The clone data map 400 is updated such that a secondary clone on a node other than the failed node is marked as a new primary clone. For example, in this case, the primary clone of the third fragment 306 (e.g., clone A.3.a 322) has gone offline as a result of the failure of brick 8, and secondary clone A.3.b 324 of the third fragment 306 has been redesignated in the updated clone data map 400 as the primary clone residing on brick 1, at rowset 2.

In a particular embodiment, in response to the detected node failure event, the clone data map is updated such that the offline clones on the failed node are marked as stale. A clone may be designated as stale when an update is made to another clone of the same fragment while the clone is offline. That is, a stale designation indicates that a clone missed one or more updates while the clone was offline. For example, referring to FIG. 4, the clone data map 400 may be updated such that the old primary clone of the third fragment 306 (e.g., clone A.3.a 322) is marked as stale, and the old secondary clone A.2.c 320 of the second fragment 304 is marked as stale. In a particular embodiment, the clone data map 400 is updated prior to a recovery event of the failed node. In a particular embodiment, an application accesses data by retrieving the new primary clone (e.g., clone A.3.b 324 of the third fragment 306) prior to the recovery event. This allows the application to continue functioning while the placement of underlying data changes.

In a particular embodiment, when the node is restarted after the node failure, the method includes detecting a node recovery event of the failed node and performing a clone refresh operation on the old primary clone and on the old secondary clone that were marked as stale. For example, referring to FIG. 4, the old primary clone A.3.a 322 of the third fragment 306 and the old secondary clone A.2.c 320 of the second fragment 304 were marked as offline or stale. When the node is restarted (e.g., when brick 8 is restarted), the clone refresh operation is performed on clone A.3.a 322 of the third fragment 306 and on clone A.2.c of the second fragment 304. The method further includes marking the refreshed clones as either primary or secondary and updating the clone data map to designate the old primary clone as primary (instead of stale or offline) and to designate the old secondary clone as secondary (instead of stale or offline). For example, the clone data map 400 of FIG. 4 may be updated so that clone A.3.a 322 of the third fragment 306 is redesignated as primary, and clone A.3.b 324 of the third fragment 306 is redesignated as secondary. Similarly, the clone data map 400 of FIG. 4 may be updated so that clone A.2.c 320 of the second fragment 304 is redesignated as secondary. The clone refresh operation may occur at substantially the same time as the restart of the failed node or at a later time.

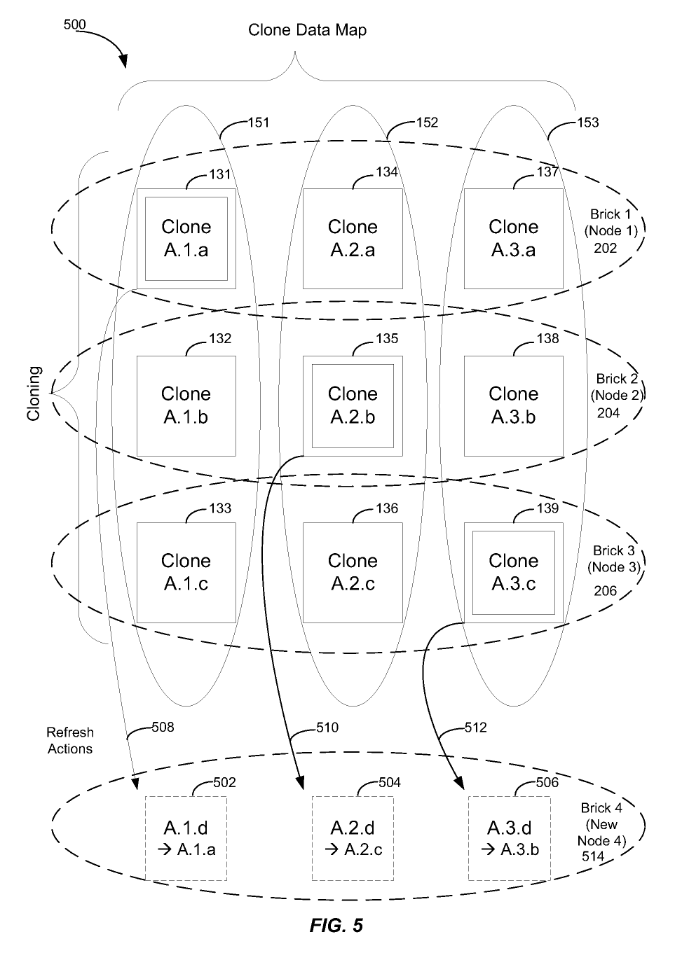

Referring to FIG. 5, a diagram illustrating migration of clones to a new node is shown at 500. Data fragments 151, 152, and 153 are shown. The first fragment 151 includes a primary clone A.1.a 131, a first secondary clone A.1.b 132, and a second secondary clone A.1.c 133. The second fragment 152 includes a first secondary clone A.2.a 134, a primary clone A.2.b 135, and a second secondary clone A.2.c 136. The third fragment 153 includes a first secondary clone A.3.a 137, a second secondary clone A.3.b 138, and a primary clone A.3.c 139. The primary clone A.1.a 131 of the first fragment 151, the first secondary clone A.2.a 134 of the second fragment 152, and the first secondary clone A.3.a 137 of the third fragment 153 are shown as residing on a first node 202 (e.g., Brick 1). The first secondary clone A.1.b 132 of the first fragment 151, the primary clone A.2.b 135 of the second fragment 152, and the second secondary clone A.3.b 138 of the third fragment 153 are shown as residing on a second node 204 (e.g., Brick 2). The second secondary clone A.1.c 133 of the first fragment 151, the second secondary clone A.2.c 136 of the second fragment 152, and the primary clone A.3.c 139 of the third fragment 153 are shown as residing on a third node 206 (e.g., Brick 3).

FIG. 5 illustrates a method of adding a new node to a node cluster. A fourth node 514 (e.g., Brick 4) is to be added to the node cluster. The method includes identifying a set of clones to migrate to a new node of a computing system. Each clone in the set of clones comprises a replicated data fragment stored at a different storage location at the computing system. In a particular embodiment, the different storage location is a different node or a different memory location.

In the embodiment shown in FIG. 5, the set of clones to be migrated to the new node 514 (e.g. Brick 4) are identified as the primary clone A.1.a 131 of the first fragment 151 residing on the first node 202 (e.g., Brick 1), the second secondary clone A.2.c 136 of the second fragment 152 residing on the third node 206 (e.g., Brick 3), and the second secondary clone A.3.b 138 of the third fragment 153 residing on the second node 204 (e.g., Brick 2), as shown in phantom at 502, 504 and 506, respectively. Once migrated to the fourth node 514 (e.g., Brick 4), each of the clones may then be refreshed using the corresponding current primary clone in the fragment from which they originally came. For example, the current primary clone A.1.a 131 of the first fragment 151 refreshes the migrated clone 502 as shown at 508, the current primary clone A.2.b 135 of the second fragment 152 refreshes the migrated clone 504 as shown at 510, and the current primary clone A.3.c 139 of the third fragment 153 refreshes the migrated clone 506 as shown at 512.

A clone is migrated by creating a new secondary clone while the original source clone continues to function (as a primary clone or as a secondary clone). For example, the migrated clone 502 begins as a new secondary clone A.1.d of the first fragment 151. Similarly, the migrated clone 504 begins as a new secondary clone A.2.d of the second fragment 152, and the migrated clone 506 begins as a new secondary clone A.3.d of the third fragment 153. The method includes creating an entry in a clone data map for the new node for each of the clones in the set of clones to generate new clones. For example, entries for the migrated clones 502, 504 and 506 may be created in the clone data map for the fourth node 514 (e.g., Brick 4). In a particular embodiment, a new empty clone is created by adding the clone entry to a clone data map.

Once the new secondary clones are created on the fourth node 514 (e.g., Brick 4), the new secondary clones may be stale (e.g., the new secondary clones have not received updates during creation). The new secondary clones are refreshed, resulting in refreshed new secondary clones. For example, the migrated clone 502, originally a new secondary clone A.1.d, is refreshed (as shown at 508) to become a refreshed new secondary clone A.1.d. The method includes refreshing each of the new clones from a corresponding current primary clone to generate new refreshed clones. For example, the migrated clone 502 is refreshed from the corresponding current primary clone A.1.a 131 of the first fragment 151, the migrated clone 504 is refreshed from the corresponding current primary clone A.2.b 135 of the second fragment 152, and the migrated clone 506 is refreshed from the corresponding current primary clone A.3.c 139 of the third fragment 153.

In a particular embodiment, refreshing each of the new clones from the corresponding current primary clone includes retrieving data from memory at the location of the primary clone and then copying that data and storing that data in memory at the new migrated clone locations. In another particular embodiment, the state of each of the new refreshed clones is set by writing a state entry into the clone data map associated with the clone entry.

Once the new secondary clones are refreshed, the method includes designating each of the new refreshed clones as either primary or secondary in the clone data map. For example, as shown in the embodiment of FIG. 5, the migrated clone 502 may be designated as a new primary clone A.1.a of the first fragment 151 in the clone data map. In a particular embodiment, the old primary clone A.1.a 131 of the first fragment 151 is then taken offline and deleted. As a further example, as shown in the embodiment of FIG. 5, the migrated clone 504 may be designated as a new secondary clone A.2.c of the second fragment 152 in the clone data map, and the migrated clone 506 may be designated as a new secondary clone A.3.b of the third fragment 153 in the clone data map. In a particular embodiment, the old secondary clone A.2.c 136 of the second fragment 153 and the old secondary clone A.3.b 138 of the third fragment 153 are then taken offline and deleted.

Adding additional nodes to the node cluster allows an administrator, or an automated tool, to scale up a cluster to accommodate the changing needs of a workload, providing for enhanced scalability. The number of additional nodes added to the node cluster may be determined based on a number of factors. For example, the number of additional nodes added to the node cluster may be determined based on a desired clone redundancy level or to maintain a selected clone redundancy level. As another example, the number of additional nodes added to the node cluster may be determined based on a desired scale of the node cluster (e.g., the desired workload of the node cluster).

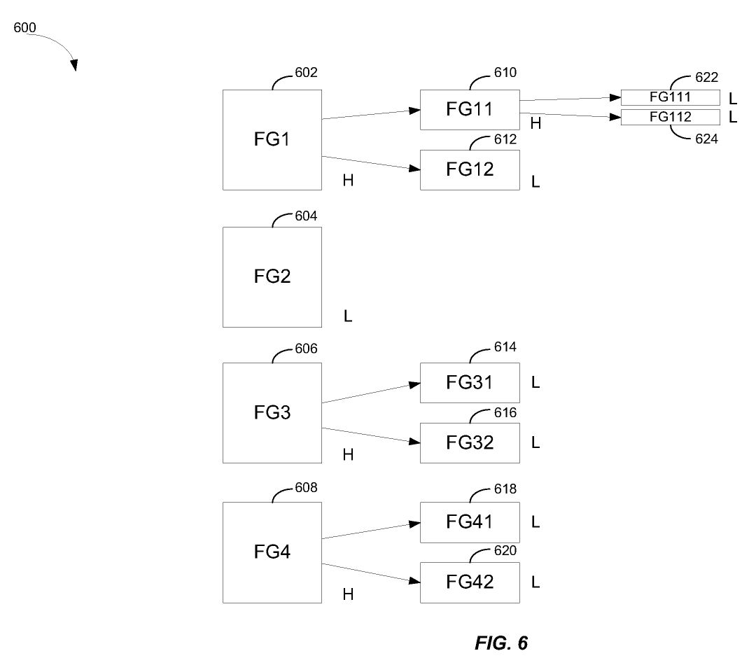

Referring to FIG. 6, a diagram illustrating a method of reducing fragment size to reduce load on the fragment or to bring the fragment size closer to an average fragment size is shown at 600. The method may be implemented using a computer-readable medium, where the computer-readable medium includes instructions that cause a processor to implement the method described. The method includes identifying fragments in the set of data fragments that have heavy usage or that have a large fragment size. In a particular embodiment, fragments are identified that have a larger than average fragment. For example, the identified fragments may have a fragment size that is significantly larger than average. In another particular embodiment, each of the data fragments has a similar size or the same size. In a particular embodiment, the method further includes creating a set of data fragments, where each data fragment has a substantially similar size. The method includes reducing the size of the identified fragments that have heavy usage until the load on each of the identified fragments is substantially the same as the other fragments. The size of the data fragment is reduced by performing one or more data fragment split operations that are non-observable by an associated application. The method includes, after reducing the size of the identified fragments, performing node load balancing by placing substantially the same number of primary clones on each node of the node cluster. Similarly, substantially the same number of secondary clones may be placed on each node of the node cluster. The utility of the node cluster may be reduced if there are bottlenecks or if one node is overloaded. Distributing the clones between nodes of the node cluster is performed so that the processor load is balanced between bricks.

For example, FIG. 6 shows a first fragment FG1 602, a second fragment FG2 604, a third fragment FG3 606, and a fourth fragment FG4 608. The first fragment FG1 602 is shown as having a high load (H), the second fragment FG2 604 has a low load (L), the third fragment FG3 606 has a high load, and the fourth fragment FG4 608 has a high load. As a result of the high load of the first fragment FG1 602, the first fragment FG1 602 is split into fragment FG11 610 and fragment FG12 612. Fragment FG12 612 is shown as having a low load, resulting in no further splits. Fragment FG11 610 is shown as having a high load and is further split into fragment FG111 622 and fragment FG112 624. Both fragment FG111 622 and fragment FG112 624 have low loads. Therefore, fragments FG111 622 and FG112 624 are not split. As shown, the second fragment FG2 604 has a low load. Therefore, the second fragment FG2 604 is not split. The third fragment FG3 606, having a high load, is split to fragment FG31 614 and fragment FG32 616, both of which have low loads, resulting in no further splitting. The fourth fragment FG4 608 is shown having a high load and is split into fragment FG41 618 and fragment FG42 620, both of which have low loads, resulting in no further splitting.

In a particular embodiment, after performing the load balancing of the data fragments, substantially the same number of primary and secondary clones are located on each node. In a particular embodiment, nodes are selected for placement on nodes of the node cluster using a round robin method. In a particular embodiment, the application is a business application and the data fragments are associated with data of a structured query language (SQL) server. In a particular embodiment, at least one of the identified fragments is a partitioned data item associated with a database object.

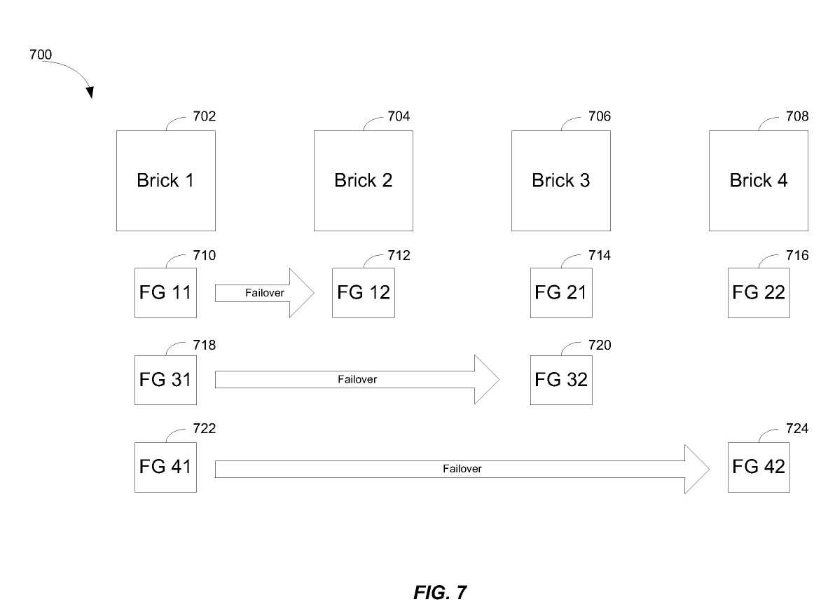

Referring to FIG. 7, a block diagram illustrating a node failover event is shown at 700. Illustrative bricks Brick 1 702, Brick 2 704, Brick 3 706, and Brick 4 708 are shown. FIG. 7 shows fragments (in a logical sense) that are representations of the availability of a primary clone of a fragment. For example, a first fragment includes a primary clone FG11 710 on Brick 1 702 and a secondary clone FG 12 712 on Brick 2 704. As a further example, a third fragment has a primary clone FG 31 718 on Brick 1 702 and a secondary clone FG 32 720 on Brick 3 706, and a fourth fragment has a primary clone FG 41 722 on Brick 1 702 and a secondary clone FG 42 724 on Brick 4 708. A second fragment has a first clone FG21 714 on Brick 3 706 and a second clone FG22 716 on Brick 4 708. After a node fails, the clones on the node are no longer online. The failed node may have one or more primary clones, such that new primary clones are to be designated in the clone data map.

For example, Brick 1 702 includes the primary clone FG11 710 of the first fragment, the primary clone FG31 718 of the third fragment, and the primary clone FG41 722 of the fourth fragment. To maintain load balance in the node cluster, a new primary clone is designated such that the node cluster remains load balanced after the designation. A fragment may be logically failed over by updating a clone data map to update a clone designation from secondary clone to primary clone of the data fragment. Upon a failure of Brick 1, the clone data map is updated such that the data fragments on Brick 1 702 appear to have moved to other Bricks. For example, the secondary clone FG12 712 of the first fragment is updated in the clone data map to be the new primary clone of the first fragment, while the old primary clone FG11 710 on the failed Brick 1 702 is designated offline in the clone data map. As a further example, the secondary clone FG32 720 of the third fragment on Brick 3 706 is updated in the clone data map to be the new primary clone of the third fragment, while the old primary clone FG31 718 on the failed Brick 1 702 is designated offline in the clone data map. As another example, the secondary clone FG42 724 of the fourth fragment on Brick 4 708 is updated in the clone data map to be the new primary clone of the fourth fragment, while the old primary clone FG41 722 on the failed Brick 1 702 is designated offline in the clone data map. Thus, the clone data map is updated such that the data fragments on the failed node (e.g., Brick 1 702) appear to have moved across all the other nodes of the node cluster (e.g., Brick 2 704, Brick 3 706, and Brick 4 708).

In a particular embodiment, even after a node failure, all the nodes in the cluster have the same number of primary data clones. To accomplish this, in an N node cluster, every node has at least N−1 primary clones. The corresponding N−1 secondary clones of these primary clones are placed on the remaining N−1 nodes (one on each node). This way, when a node fails, each of the remaining nodes has access to N primary clones. Although FIG. 7 shows N−1 primary clones only on the first node 702 (in this case N=4), the approach is applied to every node, resulting in every node having N−1 primary clones. In such a system, there are a total of N*(N−1) primary clones.

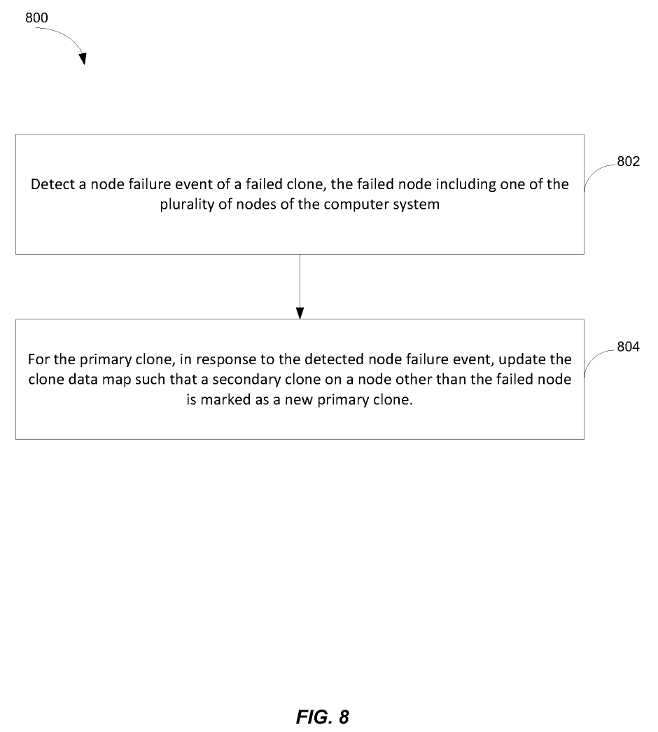

Referring to FIG. 8, a method 800 of updating a clone data map associated with a plurality of nodes of a computer system is shown. At 802, the method 800 includes detecting a node failure event of a failed node. For example, referring to FIG. 7, the node failure event detected is the failure of Brick 1 702. The failed node includes one of a plurality of nodes of the computer system. At 804, the method 800 includes updating the clone data map for the primary clone in response to the detected node failure event. The clone data map is updated such that a secondary clone on a node other than the failed node is marked as a new primary clone. For example, referring to FIG. 7, the clone data map is updated such that the secondary clone FG12 712 of the first fragment on Brick 2 704 is marked as the new primary clone for the first fragment. As a further example, the clone data map is updated such that the secondary clone FG32 720 of the third fragment on Brick 3 706 is marked as the new primary clone for the third fragment. As another example, the clone data map is updated such that the secondary clone FG42 724 on Brick 4 708 is marked as the new primary clone of the fourth fragment. The placement of the secondary clone on the node other than the failed node allows the secondary clone to serve as a readily available backup, allowing for quick replacement of the primary clone on the failed node. This enables an application to continue functioning while the placement of underlying data changes, providing high availability for the application in the event of node failure.

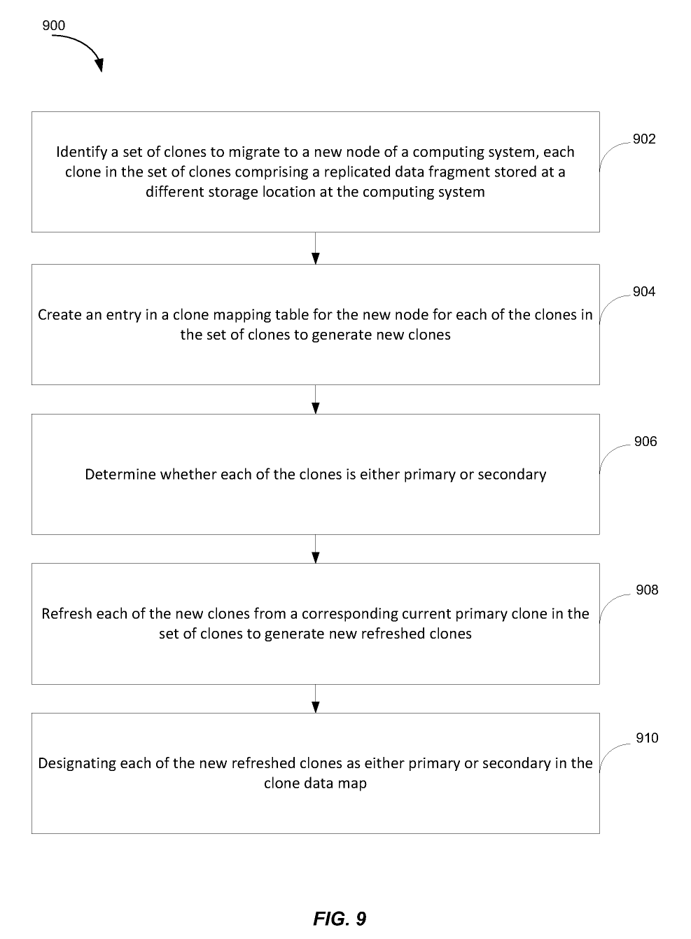

Referring to FIG. 9, a method 900 of adding a node to a node cluster is shown. The method 900 includes identifying a set of clones to migrate to a new node of a computing system, at 902. Each clone in the set of clones includes a replicated data fragment stored at a different storage location at the computing system. The method 900 includes creating an entry in a clone data map for the new node for each of the clones in the set of clones to generate new clones, at 904. In a particular embodiment, the method 900 includes determining whether each of the migrated clones is either a primary clone or a secondary clone, at 906. The method 900 includes refreshing each of the new clones from a corresponding current primary clone in the set of clones to generate new refreshed clones, at 908. The method 900 further includes designating each of the new refreshed clones as either primary or secondary in the clone data map, at 910. In a particular embodiment, each of the new refreshed clones is designated as either primary or secondary based on whether the old clone was a primary clone or a secondary clone. In a particular embodiment, the method 900 also includes deleting obsolete or out-of-date clones in the set of clones. Adding additional nodes to the node cluster allows an administrator, or an automated tool, to scale up a cluster to accommodate the changing needs of a workload, providing for enhanced scalability. The number of additional nodes added to the node cluster may be determined based on a desired clone redundancy level or to maintain a selected clone redundancy level.

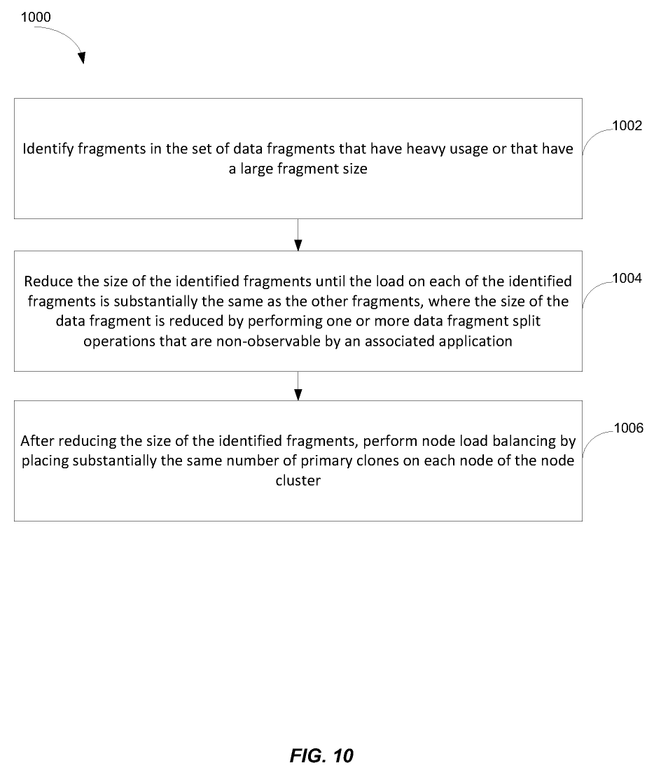

Referring to FIG. 10, a method 1000 of load balancing clones across nodes of a node cluster is shown. In a particular embodiment, the method of load balancing is implemented using instructions embedded in a computer-readable medium. The method 1000 includes identifying fragments in the set of data fragments that have heavy usage or that have a large fragment size, at 1002. In a particular embodiment, fragments are identified that have a larger than average fragment. For example, the identified fragments may have a fragment size that is significantly larger than average. In another particular embodiment, each of the data fragments has a similar size or the same size. The method 1000 includes reducing the size of the identified fragments that have heavy usage until the load on each of the identified fragments is substantially the same as the other fragments, at 1004. The size of the data fragment is reduced by performing one or more data fragment split operations that are non-observable by an associated application. The method 1000 includes, after substantially reducing the size of the identified fragments, performing node load balancing by placing substantially the same number of primary clones on each node of the node cluster, as shown at 1006. The method of load balancing clones across multiple nodes of the node cluster reduces the likelihood of negative performance of a cluster and to accommodate bottlenecks or overloaded nodes.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of updating a clone data map associated with a plurality of nodes of a computer system, the method comprising:
detecting a node failure event of a failed node, the failed node comprising one of the plurality of nodes of the computer system, wherein the failed node includes a primary clone and a secondary clone;
for the primary clone, in response to the detected node failure event, updating the clone data map, the clone data map including node identification data and clone location data, wherein the clone data map is updated such that a secondary clone on a node other than the failed node is marked as a new primary clone.

2. The method of claim 1, wherein in response to the detected node failure event, the clone data map is updated such that the primary clone is marked as a first offline clone and the secondary clone on the failed node is marked as a second offline clone.

3. The method of claim 2, further comprising detecting a node recovery event of the failed node and performing a clone refresh operation on the first offline clone and on the second offline clone, and updating the clone data map to mark the first offline clone as primary and to mark the second offline clone as secondary.

4. The method of claim 1, wherein an application accesses data by retrieving the new primary clone prior to a recovery event of the failed node.

5. A method of adding a node to a node cluster, the method comprising:
identifying a set of clones to migrate to a new node of a computing system, each clone in the set of clones comprising a replicated data fragment stored at a different storage location at the computing system;
creating an entry in a clone data map for the new node for each of the clones in the set of clones to generate new clones;
refreshing each of the new clones from a corresponding current primary clone in the set of clones to generate new refreshed clones; and
designating each of the new refreshed clones as either primary or secondary in the clone data map.

6. The method of claim 5, wherein the different storage location is a different node or a different memory location.

7. The method of claim 5, wherein a first new clone is set as a new primary clone in the clone data map and a second new clone is set as a new secondary clone in the clone data map.

8. The method of claim 5, wherein a new empty clone is created by adding the clone entry to a clone data map.

9. The method of claim 5, wherein the state of each of the new refreshed clones is set by writing a state entry in the clone data map associated with the clone entry.

10. The method of claim 5, wherein refreshing each of the new clones from the corresponding current primary clone includes retrieving data from memory at the location of the corresponding current primary clone and then copying that data and storing that data in memory at the new clone locations.

11. The method of claim 5, further comprising determining that each of the clones in the set of clones is either primary or secondary, and wherein when a particular clone to be migrated is a primary clone, the particular clone is designated as a new primary clone and an old clone is designated as a secondary clone.

12. The method of claim 11, further comprising deleting old, obsolete or out-of-date clones in the set of clones.

13. The method of claim 5, wherein the set of clones to migrate includes all of the clones on a node of the computing system, and wherein the node of the computing system is removed from the node cluster.

14. A computer-readable medium, comprising:
instructions, that when executed by a processor, cause the processor to identify fragments in a set of data fragments that have heavy usage or that have a large fragment size;
instructions, that when executed by the processor, cause the processor to reduce the size of the identified fragments until a load on each of the identified fragments is substantially the same as the other fragments, wherein the size of the data fragment is reduced by performing one or more data fragment split operations that are non-observable by an associated application;
instructions, that when executed by the processor after reducing the size of the identified fragments, cause the processor to perform node load balancing by placing a substantially similar number of primary clones on each node of a node cluster.

15. The computer-readable medium of claim 14, further comprising instructions that, when executed by the processor, cause the processor to create a set of data fragments, each data fragment having a substantially similar size.

16. The computer-readable medium of claim 14, wherein after the load balancing, a substantially similar number of secondary clones are placed on each node of the node cluster.

17. The computer-readable medium of claim 14, wherein nodes are selected for placement on nodes of the node cluster using a round robin method.

18. The computer-readable medium of claim 14, wherein the application is a business application and wherein the data fragments are associated with data of a structured query language (SQL) server.

19. The computer-readable medium of claim 14, wherein at least one of the identified fragments is a partitioned data item associated with a database object.

20. The computer-readable medium of claim 14, wherein when a node fails, the clones on the failed node are distributed across all the other nodes of the node cluster.
